(19) United States
(12) Patent Application Publication
(10) Pub. No.: US 2002/0073633 A1
(43) Pub. Date: Jun. 20, 2002

(54) Anti-perching device for post frame buildings

(76) Inventors: Michael J. Schlichting, Lena, IL (US); Kurt J. Schlichting, Lena, IL (US)

Correspondence Address: KEITH FRANTZ, 401 WEST STATE STREET, SUITE 200, ROCKFORD, IL, 61101

(21) Appl. No.: 09/740,105

(22) Filed: Dec. 18, 2000

(51) Int. Cl. E04H 17/00; A01M 1/00; E04D 1/30

(52) U.S. Cl. 52/101; 52/57; D25/38; 256/11; 43/1

(57) ABSTRACT

An anti-perching device provided with elongated, laterally spaced, substantially vertical legs adapted to slip over construction frame members, elongated continuous side members extending upwardly therefrom at an angle to obscure the upper horizontal surfaces of the frame members and preclude perching thereon, an elongated continuous upper surface peak configuration extending along the length thereof and shaped to preclude the presentation of a horizontal surface for perching, and an integral stop mechanism for consistent vertical positioning of the device on the frame members.

### BACKGROUND OF THE INVENTION

1. Field of Invention

The present invention relates generally to apparatus for discouraging perching of birds.

More particularly, the invention related to apparatus for preventing perching and nesting of birds on roof support members in post frame construction buildings.

2. Description of Prior Art

Post frame construction buildings, sometimes referred to as “pole” buildings, are constructed throughout the country, and are in common use such as for storage buildings, barns, stables and homes. In many locations, the post frame buildings, and in particular the supporting structure for the roof, are not “finish” enclosed as they are when used in a home. In such instances, entry of birds into the buildings is a common occurrence, creating an ever-present problem with perching and nesting of birds in the roof supporting structure, and the associated feathers and bird dropping resulting from such perching and nesting.

Numerous prior devices have been used for discouraging birds from perching and nesting in undesired locations, primarily in and around buildings. However, these prior anti-perching devices are not particularly suitable for and have not been widely accepted for use in discouraging perching and nesting in open-structure post frame buildings. A primary difficulty in addressing the perching and nesting problem in post frame buildings is the fact that such buildings can have thousands of feet of open horizontal surfaces in the roof support structure for the birds to perch on. Thus, an effective anti-perching device must be relatively easy to handle and install along thousands of feet of relatively slender 2×4 frame construction members typically used in such buildings.

One general type of prior anti-perching device utilizes upstanding wire construction shapes, typically attached to an elongated wire support. One such early anti-perching device shown in Peles, U.S. Pat. No. 2,258,803 comprises lengths of wire bent into various shapes (e.g., circular, triangular, spiral, diamond and hexagon) and interconnected to project upwardly and form an elongated barrier to discourage perching on buildings. However, such prior wire frame devices are relatively complicated and expensive, and relatively bulky, and therefore not particularly suitable for large-scale use in post frame buildings due to the difficulties in manually handling and installing such devices over the lengths of exposed surfaces.

Another general type of anti-perching device utilizes horizontal cables connected between vertical uprights to discourage perching. For example, Gratton, U.S. Pat. No. 4,937,988 discloses a barrier comprising strands of wire secured between support brackets for discouraging pigeons from landing on balcony rails. Way, U.S. Pat. No. 5,092,088 discloses an alternate device including strands of wire strung between support brackets to discourage perching on building ledges. In a variant to these approach, Engler, U.S. Pat. No. 5,497,585 discloses an anti-perching device comprising a plurality of rotatable rings located on a cable strung between support brackets.

However, as with the wire frame anti-perching devices, such cable anti-perching devices are not particularly suitable for use in a post frame building. Stringing and tightening the hundreds of individual cables that would be necessary in a typical post frame building for anti-perching purposes would be a relatively involved, time consuming and expensive process, and have therefore found no substantial acceptance the post frame construction industry.

Other types of anti-perching devices are also known. Townsend, Jr. Et al., U.S. Pat. No. 5,606,830 discloses a collapsible, wire-construction anti-perching apparatus for draping installation over, for example, railings and wire cables. Callaghan, Jr., U.S. Pat. No. 5,765,319 discloses a barrier for vent openings comprising pivotably mounted hanging wire structures. Burdick, U.S. Pat. No. 5,850,808 discloses an anti-perching device having electrical conductors for shocking birds landing thereon. Donoho et al, U.S. Pat. No. 5,253,444 discloses a window sill anti-perching device having a base for extending along the sill and spiked top members that press fit onto the base. Hoggard et al. discloses a perching barrier including a two-part mechanical device for connection to a cross-bar between electrical power lines and a triangular structure positioned longitudinally thereon. However, as with the wire construction and cable anti-perching prior art, all of devices have numerous obvious disadvantages with regard to and are not particularly suitable for use in post frame, and have enjoyed no substantial acceptance throughout the industry.

More recently, Goergen, U.S. Pat. No. discloses an anti-perching device in the form of a hollow extrusion with a triangular cross-section that presents an inclined surface over an exterior horizontal surface such that birds either slide off or find it too difficult to perch for any length of time. A preferred method of connection of the hollow triangular extrusion to the horizontal surface is with the use of adhesive. Alternately, Goergen indicates the extrusion can be bolted or clipped to the horizontal surface. However, gluing such a structure to the thousands of linear feet of horizontal surface in a typical post frame buildings would be time consuming and therefore relatively expensive, and the extrusion of Goergen includes no provision for other connection easily or conveniently that would make it suitable for use in the post frame construction industry.

Thus, it is clear there is a need for a new and improved anti-perching device that is relatively inexpensive, relatively easy to handle and install, and suitable for use on the open horizontal surfaces present in typical post frame construction buildings.

### SUMMARY OF THE INVENTION

The general aim of the present invention is to provide a new and improved anti-perching device which, while suitable for other uses, is especially suitable for use in connection with post frame construction buildings.

Another objective of the invention is to provide such an anti-perching device that is also suitable for use and installation as an anti-nesting device for post frame construction buildings.

Yet another objective is to provide such an anti-perching device that is lightweight, durable, and easy to manufacture, handle and install over the thousands of feet of exposed horizontal surfaces typically found on the roof support structure of post frame construction buildings.

These and other objectives and advantages of the invention will become more apparent from the following detailed description when taken in conjunction with the accompanying drawings.

In certain preferred embodiments, an anti-perching device hereof includes elongated laterally spaced legs adapted to slip over the typically 2×4 inch, and sometimes 4×4 inch, frame members in the roof support structure of a post frame building, one or more sides inclined upwardly from the legs to cover the horizontal surfaces of the frame and present an inclined surface(s) and an upper peak configuration shaped to discourage perching thereon, and internal provision for consistent vertical positioning on the frame members. Other preferred embodiments are formed with legs of an unequal length to facilitate instillation, and a peak configuration having a series of longitudinally spaced upper points.

### BRIEF DESCRIPTION OF THE DRAWINGS

FIG. 1 is a perspective view of a conventional-type post frame construction building, with a portion of the roof being broken away to reveal the construction details thereof.

FIG. 2 is an enlarged fragmentary perspective view of a portion of the building and roof structure, and showing two alternate anti-perching devices installed thereon.

FIG. 3 is a right-rear perspective view of one embodiment of an anti-perching device incorporating the unique aspects of the present invention, the device being illustrated as installed onto a structural member shown in dashed lines.

FIG. 4 is a right end view of the anti-perching device shown in FIG. 3 as installed, the left end view being a mirror image thereof.

FIGS. 5-6 are left-front perspective and left end views, respectively, of the anti-perching device shown in FIG. 3.

FIGS. 7-10 are front and back elevation, and top and bottom plan views, respectively, of the anti-perching device shown in FIG. 3.

FIGS. 11-13 are left end views illustrating sequential steps for a method of installing the anti-perching device of FIG. 3.

FIGS. 14-16 are right end views illustrating sequential steps for an alternate method of installing the anti-perching device of FIG. 3.

FIGS. 17-18 are left-front perspective and left end views, respectively, of an alternate embodiment of an anti-perching device in accordance with the present invention.

FIGS. 19-20 are right-rear perspective and right end views, respectively, similar to FIGS. 3-4 as installed onto a frame member, but of a second alternate embodiment of an anti-perching device in accordance with the present invention.

FIGS. 21-22 are right-rear perspective and right end views, respectively, of the second alternate embodiment of FIGS. 19-20.

While the invention is susceptible of various modifications and alternative constructions, certain illustrated embodiments have been shown in the drawings and will be described below in detail. It should be understood, however, that there is no intention to limit the invention to the specific forms disclosed, but on the contrary, the intention is to cover all modifications, alternative constructions, and equivalents falling within the spirit and scope of the invention.

### DETAILED DESCRIPTION OF PREFERRED EMBODIMENTS

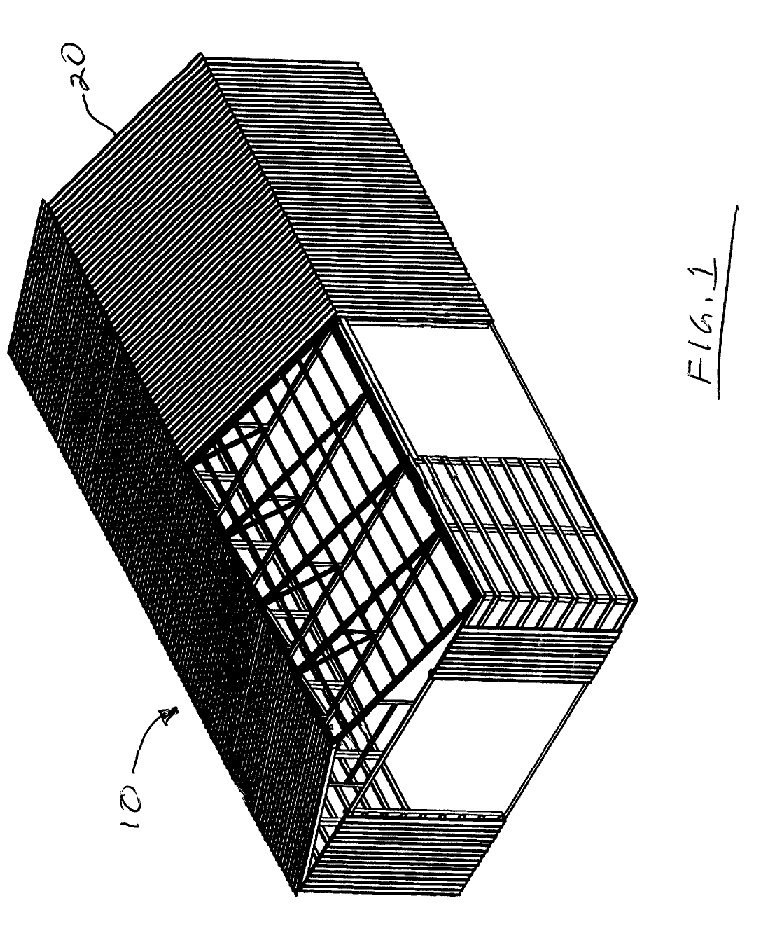

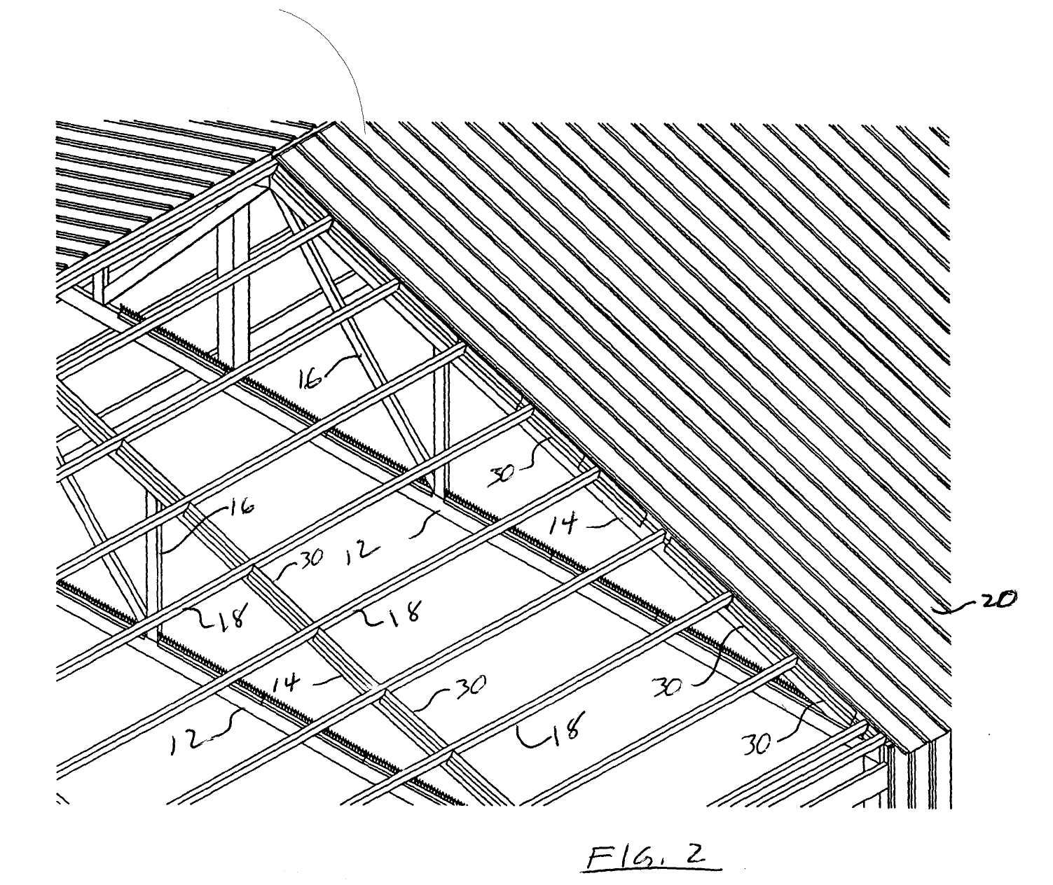

For purposes of illustration, anti-perching devices in accordance with the present invention are shown in the drawings as applied to the roof support structure of a conventional-type post frame construction building 10 (FIG. 1). In this instance, the roof support structure of the building 10 includes longitudinally spaced lower horizontal chord frame members 12 (FIG. 2) extending laterally across the width building, longitudinally spaced upper chord frame members 14 inclined downwardly on each side from the center of the roof along the roof grade, various center support frame members 16 at various angles therebetween, and laterally spaced longitudinally extending purlins 18 supported by the upper chords 14 and supporting the outer roof panels 20.

As is well known, the upper substantially horizontal surfaces of the lower chords 14, upper chords 18 and various support members 16 present inviting locations for birds to perch, and confined spaces defined in part by such substantially horizontal surfaces and particularly the spaces created between the upper chords 14 and the underside of the roof panels 20 resulting from the presence of the purlins 18 therebetween are particularly inviting places for nesting.

In accordance with the present invention, anti-perching devices uniquely adapted for low cost, durability, and ease of manufacture, handling and installation onto the typically 2×4 inch, and sometimes 4×4 inch, frame members of post frame construction buildings are provided to eliminate the associated substantially horizontal surfaces. As a result, birds are prevented from perching and nesting thereon, and the dirt, mess and bird droppings associated therewith are eliminated.

More particularly, anti-perching devices in accordance with the invention are uniquely provided with elongated, laterally spaced, substantially vertical legs adapted to slip over the construction frame members, at least one elongated continuous side member that extends upwardly therefrom at an angle to obscure the upper horizontal surfaces of the frame members and preclude perching thereon, an elongated continuous upper surface peak configuration extending along the length thereof and shaped to preclude the presentation of a horizontal surface for perching, and a stop mechanism for consistent vertical positioning of the device on the frame members.

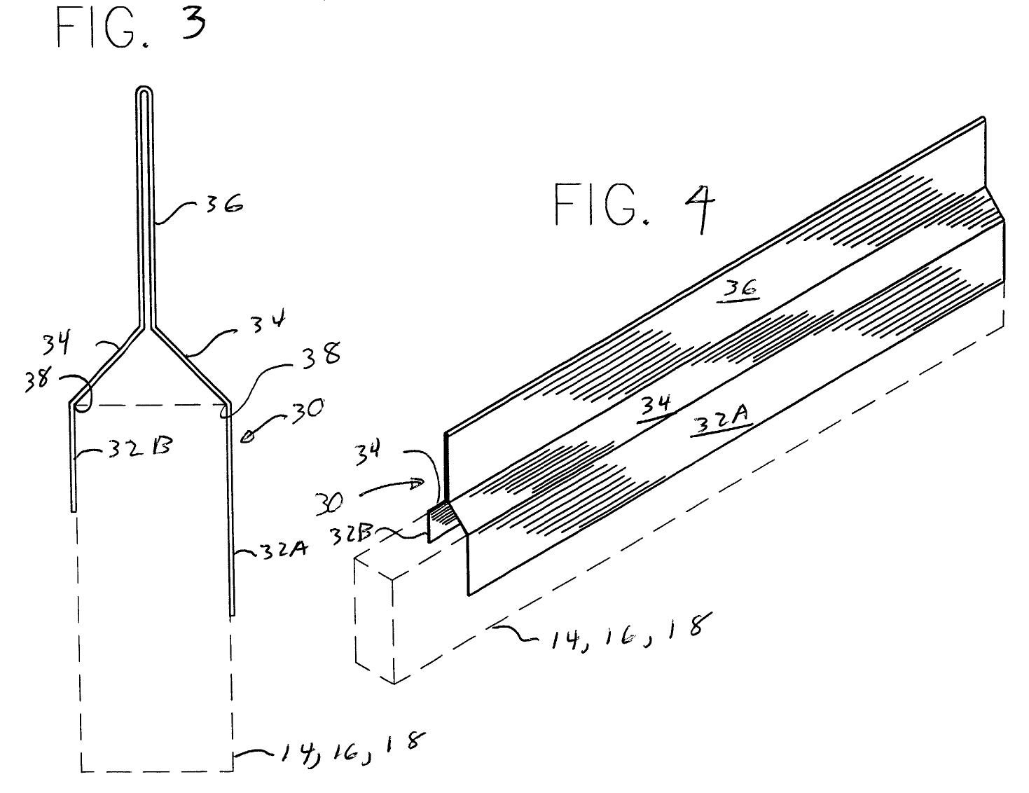

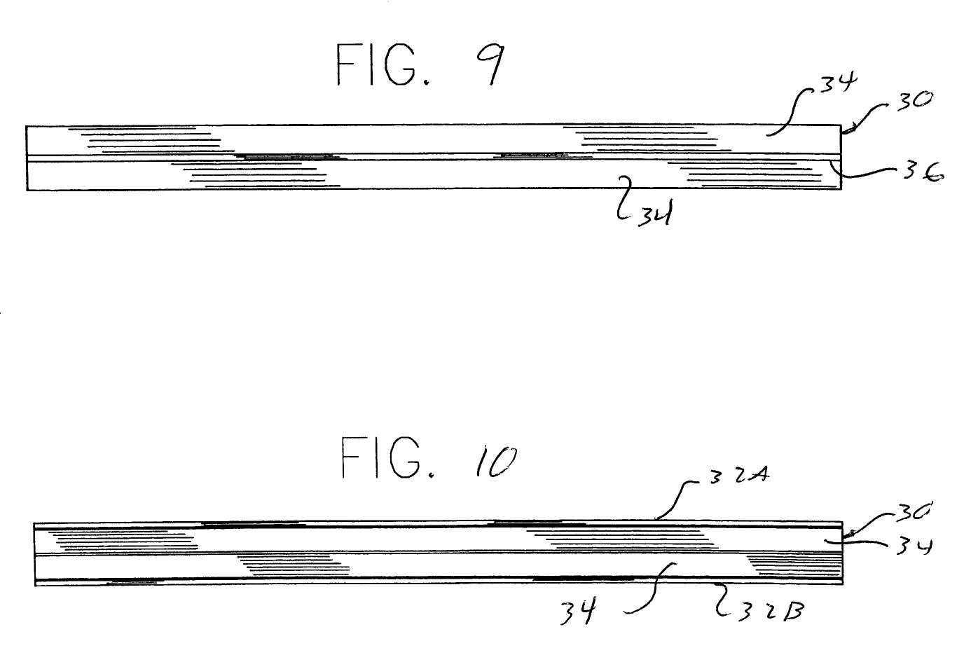

In carrying out the invention, one embodiment of an anti-perching device 30 (shown in detail in FIGS. 3-10) is formed with elongated, laterally spaced legs 32A and 32B sized to snugly slip over the width of the frame members 12, 14, 16, a pair of elongated side members 34 extending upwardly from associated upper edge portions of the legs 32A and 32B at an angle of between approximately 30 degrees and 60 degrees, and preferably at approximately 45 degrees, toward one another, and a projection 36 extending upwardly from coincident or adjacent upper edge portions of the angled side members.

The anti-perching device 30 is preferably manufactured with a generally automated, high volume process as a bending, molding or extrusion process, and from a durable, resilient, lightweight material such as sheet metal or plastic.

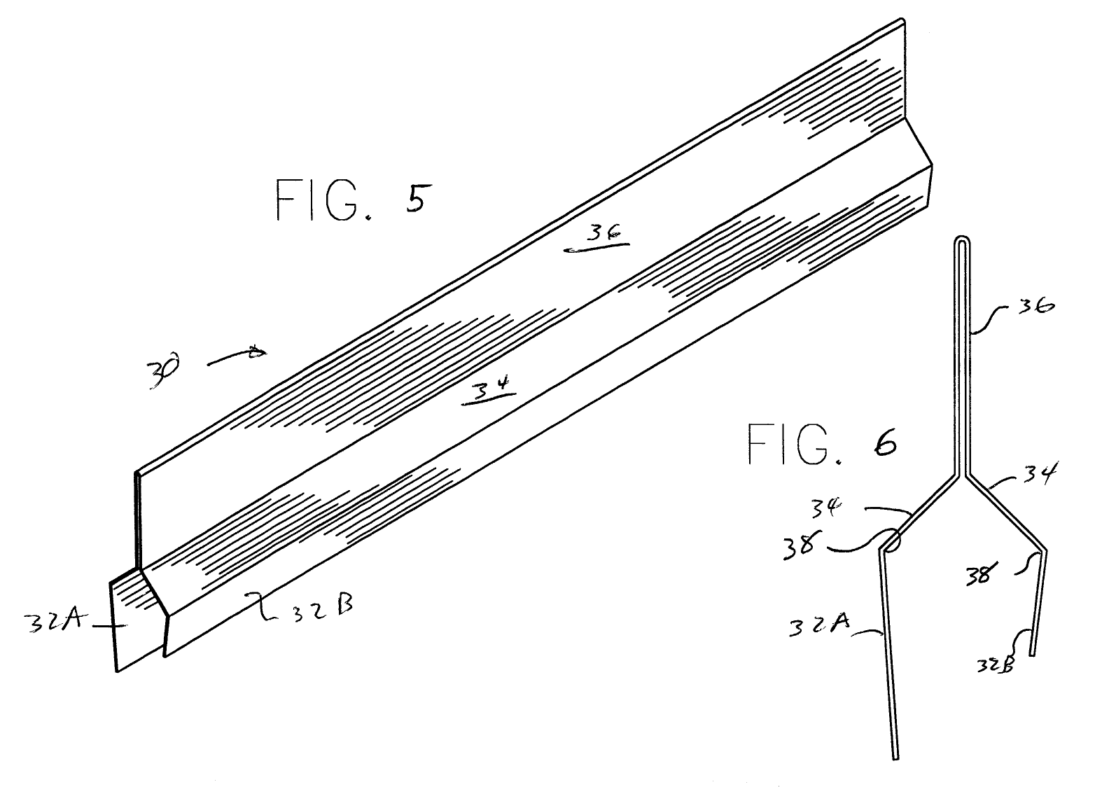

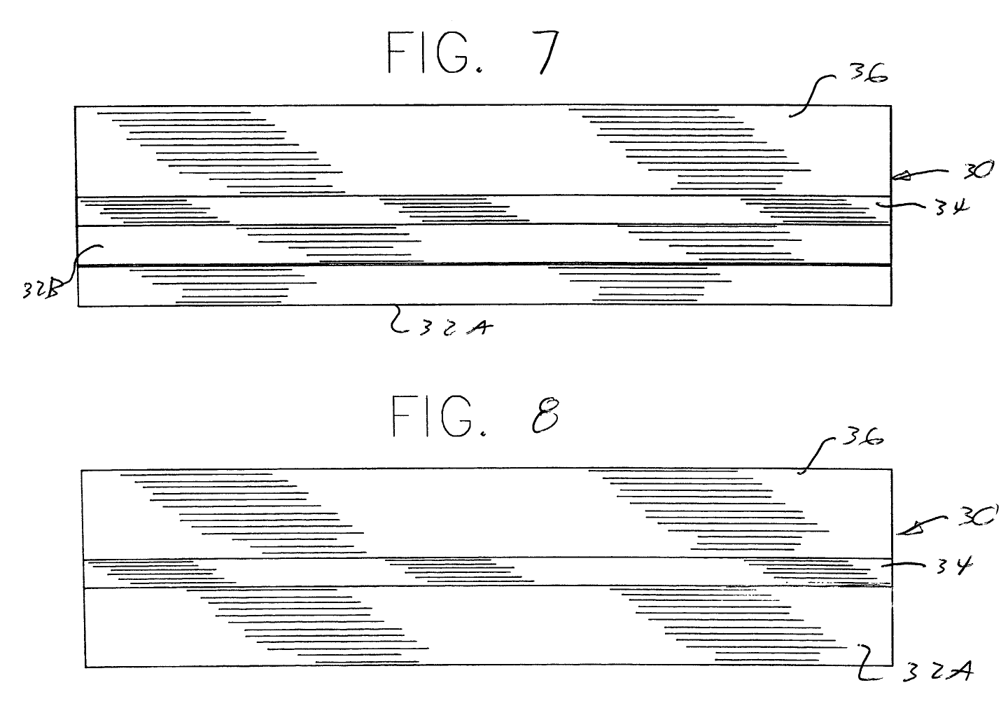

During fabrication of the anti-perching device 30, the legs 32A and 32B may be formed extending vertically as shown in FIGS. 3-4. Alternately and preferably, to insure a snug fit and accommodate some dimensional variation in the width of the several frame members, the legs 32A and 32B are initially formed at a small angle, with their free ends inclined toward one another as shown in FIGS. 5-6, and are separated to a vertical parallel relationship when installed onto the frame member as shown in FIGS. 3-4. This results in a slight elastic tension between the legs and the frame member to assist in holding the installed anti-perching device in place; the desired angle between the legs being determined based on the desired snugness of fit and elasticity of the material from which the anti-perching device is fabricated.

As shown in the drawings, one leg 32B is also preferably shorter than the other leg 32A. This unique arrangement assists in ease of installation of the anti-perching device 30 (a) when the legs are formed inclined toward one another, and (b) when installing anti-perching devices onto upper chords 14 of the building.

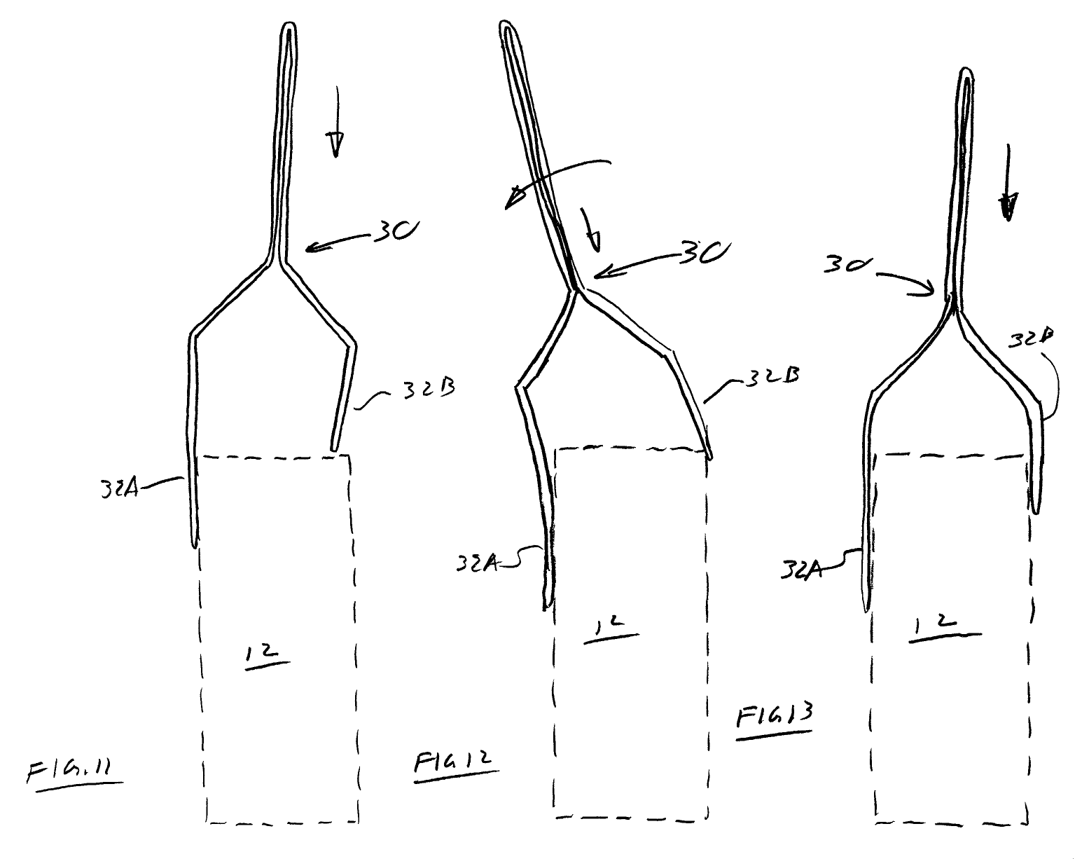

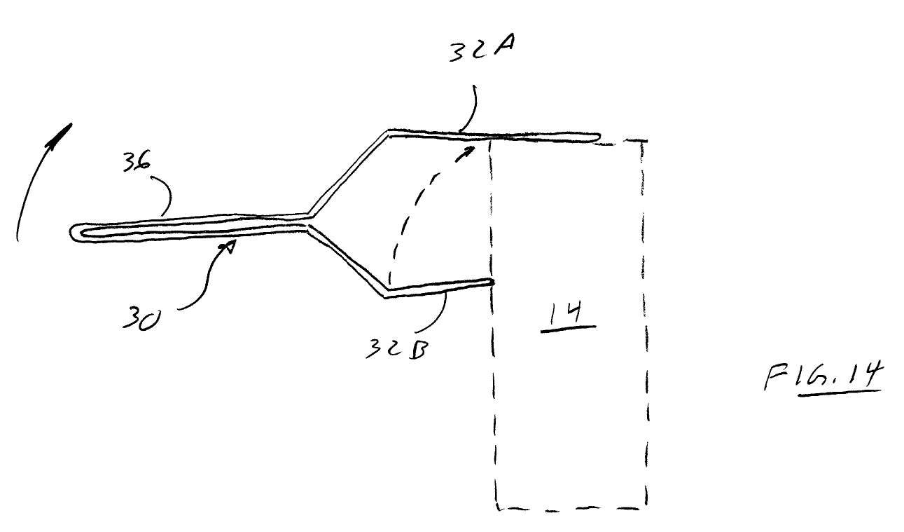

During installation of the anti-perching device 30 with the legs 32A, 32B inclined toward one another, it is apparent the device can not be simply slipped into position onto, for example a lower chord 12 since the space between the free ends of the legs is less than the width of the chord. Providing the front leg 32B shorter than the back leg 32A permits the installer to slip the longer leg 32A down along the associated side of the chord until the shorter leg 32B contacts the top of the chord, elastically rotate the shorter leg over the associated upper corner of the chord, and then push or pull the anti-perching device into place on the chord. These steps are generally illustrated sequentially in the drawings in FIGS. 11-13. The anti-perching device is then secured to the chord with a few nails or staples through the leg facing the installer which will typically be the shorter leg 32B.

Installation of the anti-perching device 30 onto upper chords 14 presents additional difficulties. First, because of the additional height above the lower chords 12, and the lack of any additional available structure for support of the installer, it may be difficult to install the anti-perching device 30 downwardly as discussed above. Vertical installation is simply precluded in certain cramped locations such as those instances when the roof panels 20 are already in place prior to installation of the anti-perching device. The presence of the roof panels in close proximity to the upper chords of a completed structure precludes installation of the devices using any substantial vertical movement component.

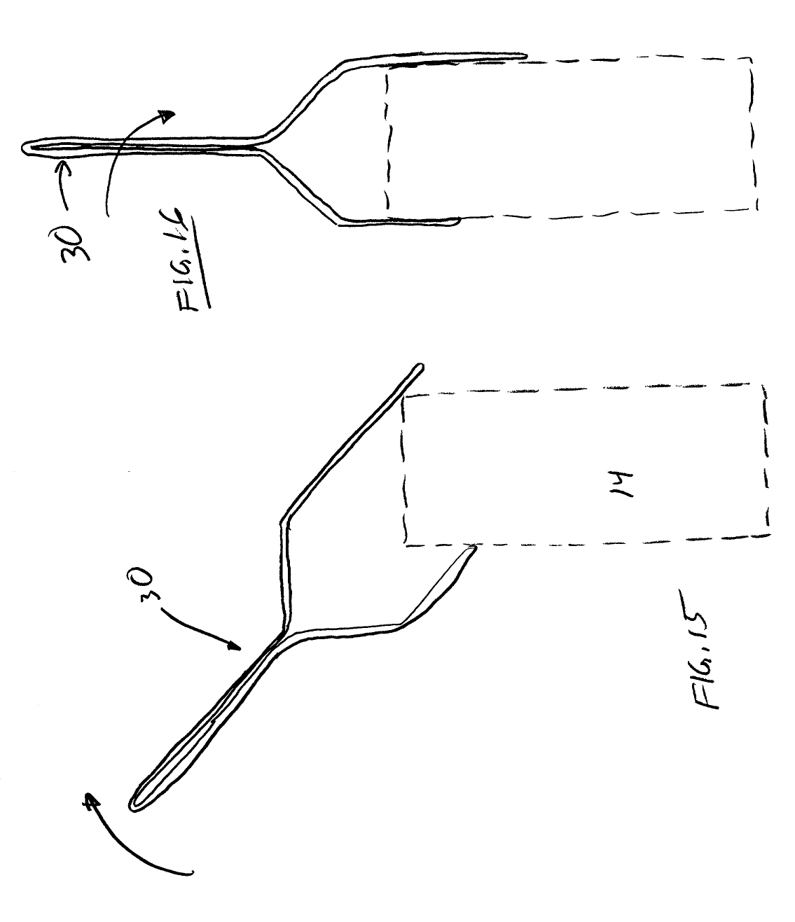

Advantageously, providing one leg 32B shorter than the other leg 32A by a length equal to or greater than approximately one-half (½) the width of the frame member (see FIG. 14) on which it is to be installed permits ease of installation in such confined spaced where vertical installation is not desirable or available. More particularly, providing one leg shorter than the other allows for installation via a unique rotating technique. In this instance, the anti-perching device 30 is oriented approximately horizontal as shown in FIG. 14, with the upright projection 36 facing the installer, the longer leg 32A resting on the top of the chord, and the free end of the shorter leg against the adjacent vertical side of the chord facing the installer. The device is then installed onto the chord by simply rotating the device such that the longer leg 32A rotates around the far upper corner of the chord (see FIG. 15), with the legs elastically separating as the longer leg slides over and then downwardly along the upper far corner of the chord, and then continuing to rotate or push the device until positioned into place on the chord (FIG. 16). In either event, the anti-perching device is again secured with a few nails or staples through the shorter leg facing the installer.

As previously mentioned, the angled sides 34 are configured to obscure the upwardly facing horizontal surfaces of the frame members, and to preclude perching thereon since birds will slide off if they land on the sides. Advantageously, providing for two sides angled toward one another simultaneously provides for an inherent “stop” mechanism to promote consistent positioning of the anti-perching device 30 when installed on the frame members. More particularly, the inside corners 38 between the legs 32A, 32B and the sides 34 provide a consistent point of reference for vertical positioning when the device is installed and pressed onto the chord until the upper corners of the chord engage the inside corners 38 of the anti-perching device. This arrangement insures consistent vertical positioning on the chord, and insures the device remains in position prior to being secured with nails or staples.

As also previously mentioned, the upright 36 is also adapted to preclude perching thereon. While an upright formed with a “sharp” end is desirable to discourage perching, a sharp end is undesirable from the standpoint of the installer's safety when pressing the device into place. Fortunately, it has been found that the upright need not be formed to precisely a sharp point at its upper edge, but that a flat or rounded upper-most surface of approximately equal to or less than 0.06 inch width will generally achieve its objective of discouraging birds from perching.

Advantageously, the angled sides 34 and upright 36 can be formed with a standard height corresponding to the height of the purlins, (i.e., approximately 3½ inches high corresponding to the height of standard sized “2×4” inch lumber) and with the rotation installation technique discussed above, the sides and upright will substantially fill the space between the upper chords and the roof panels to prevent nesting of birds therebetween.

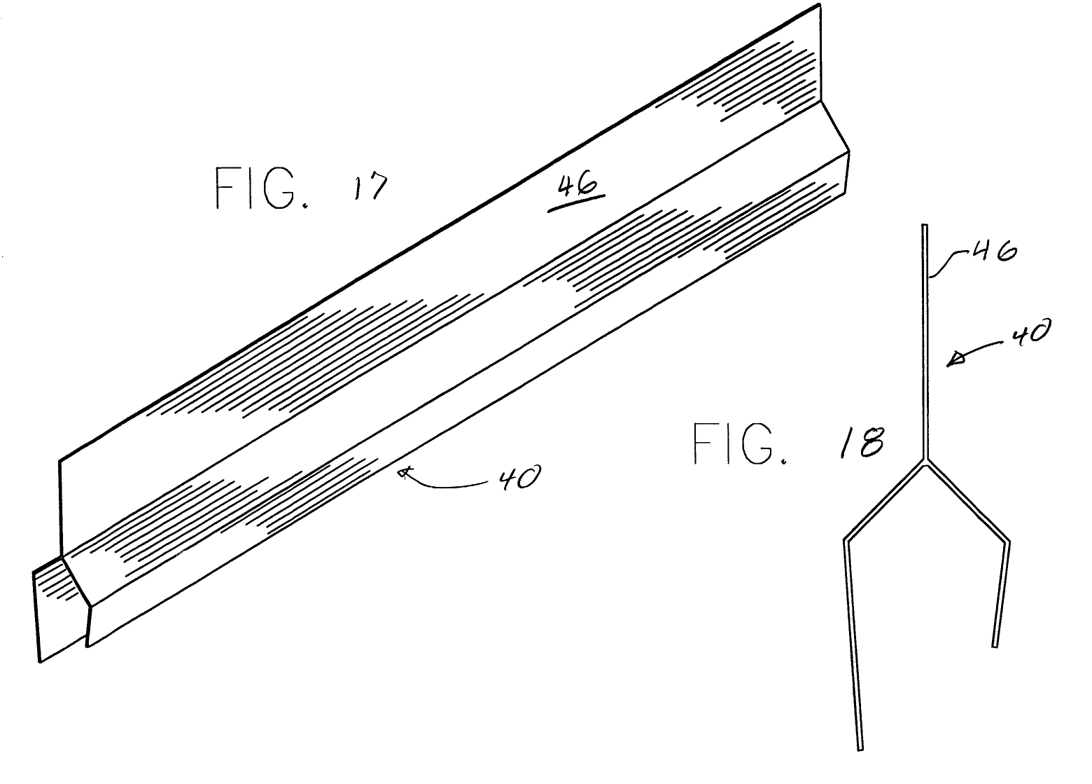

As illustrative of alternate anti-perching devices in accordance with the present invention and adapted for different manufacturing considerations, an alternate embodiment anti-perching device 40 is shown in FIGS. 17-18. In this instance, the anti-perching device is substantially similar to the device 30, except that the upright 46 is formed as a single member rather than a looping upright 36. Such an alternate embodiment is believed to be more readily susceptible to manufacture with high-volume extrusion methods rather than bending methods.

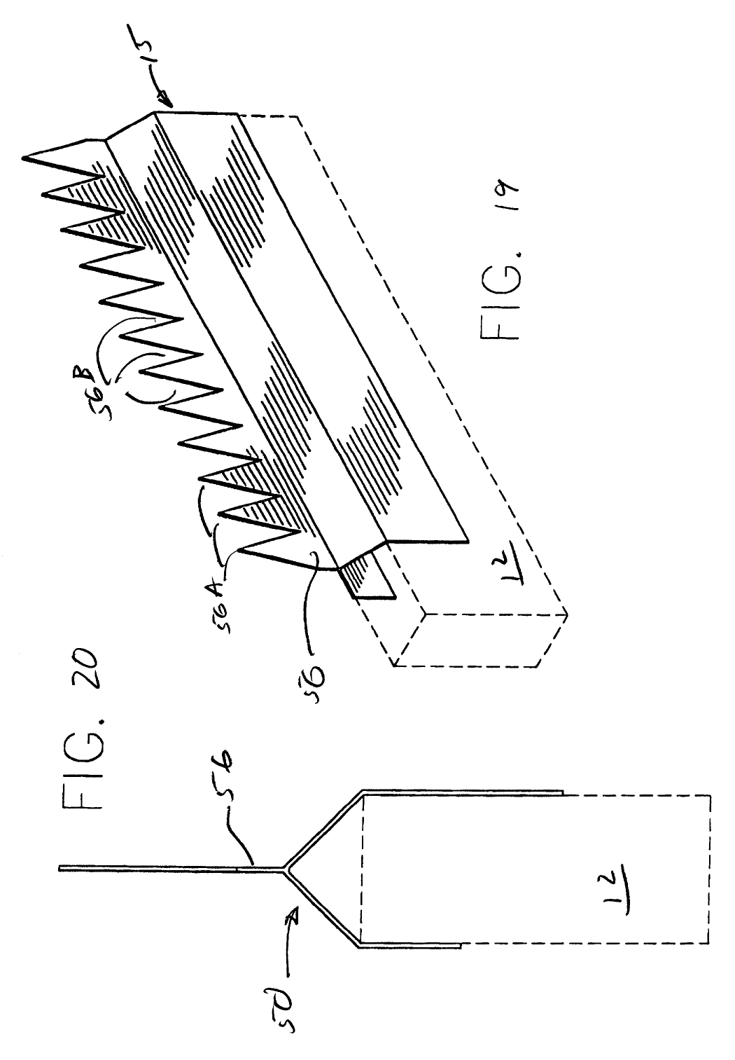

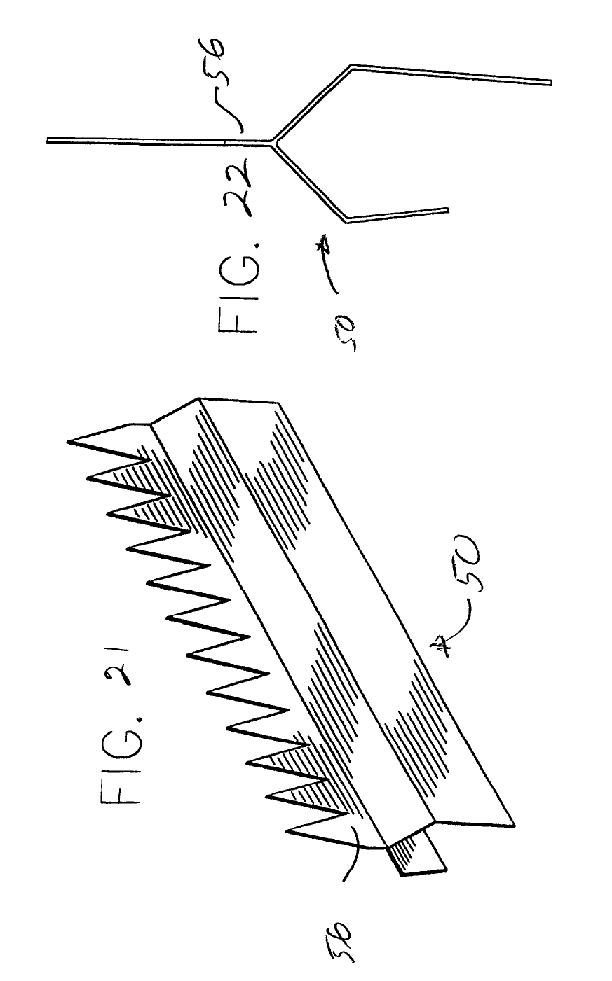

A second alternate embodiment of an anti-perching device 50 in accordance with the present invention is shown in FIGS. 19-22. In this instance, the upright 56 is formed with multiple spaced peaks 56A and valleys 56B rather than the continuous straight upper edge of the previously described embodiments 30, 40 to discourage perching thereon.

Those skilled in the art will understand and appreciate that the specific embodiments of the anti-perching device disclosed herein will be susceptible to changes and modifications within the scope of the present invention. In particular, it will be understood that the cross-sectional profile of anti-perching devices in accordance herewith may take on any of several suitable profiles, including but not limited to taller angled sides (similar to sides 34) to eliminate the upright projection (e.g., 26, 46, 56); a single angled side and a vertical side having a protruding integral “stop” profile extending inwardly therefrom for engaging one of the upper corners of the frame member (to achieve vertical positioning on the frame members); and alternately shaped peaks and valleys formed in the continuously extending upright (as compared with upright 56).

From the foregoing it will be apparent that the present invention brings to the art a new and improved anti-perching device uniquely adapted for use in connection with post frame constructions buildings to discourage and prevent perching and nesting of birds in the open roof structure typically found therein. By virtue of the elongated laterally spaced legs, resilient material construction, and integral stop mechanism, anti-perching devices hereof are quickly and easily installed over the generally horizontal roof support frame members and secured thereto, including into cramped spaced such as between upper chords and the roofing panels. And by virtue of the angled or vertical sides and optional upright of the anti-perching devices, all horizontal surfaces suitable for perching or nesting are obscured. Accordingly, anti-perching devices according to the invention provide effective yet economically viable elimination of inviting places for perching and nesting in post frame buildings.

We claim:

1. A bird anti-perching device adapted for installation onto a member having oppositely facing vertical sides and an upwardly facing upper horizontal surface, the anti-perching device comprising:
a pair of elongated, generally vertically extending, laterally spaced legs having first and second associated lower free ends and having upper aligned edge portions;
a pair of elongated, laterally spaced sides extending upwardly from the upper edge portions of the legs at an angle approaching one another, the sides having upper edge portions adjacent one another; and
an upright member extending upwardly from the upper edge portions of the sides, the upright having an uppermost edge

2. The anti-perching device of claim 1 in which the legs extend toward the lower free ends thereof at an angle, the device being made from a resilient material and the legs being laterally spaced for snugly fitting along the vertical surfaces of the construction member.

3. The anti-perching device of claim 1 in which one leg is shorter than the other leg by a length equal to approximately one-third (⅓) to two-thirds (⅔) the width of the horizontal upper surface of the construction member.

4. The anti-perching device of claim 1 in which the upright is formed with longitudinally spaced peaks and valleys defined by inclined surfaces therebetween.
